(19) United States
(12) Patent Application Publication
(10) Pub. No.: US 2021/0345835 A1
(43) Pub. Date: Nov. 11, 2021

(54) CUTTING BOARD

(71) Applicants: Georg BOERSTE, Stephanskirchen (DE); Simon Martin NORDHOFF, Ulm (DE)

(72) Inventors: Georg BOERSTE, Stephanskirchen (DE); Simon Martin NORDHOFF, Ulm (DE)

(21) Appl. No.: 17/163,498

(22) Filed: Jan. 31, 2021

(30) Foreign Application Priority Data
May 7, 2020 (EP) 20000176.6

(51) Int. Cl. A47J 47/00; A47J 43/00; F28D 9/00

(52) U.S. Cl. CPC A47J 47/005; F28D 9/0081; A47J 43/00

(57) ABSTRACT

A cutting board for domestic or gastronomic use. The board has a flat plate having an outer surface formed by pair of opposite faces and a peripheral edge. The plate is formed between the faces and within the edge with a passage having ends open at the outer surface. A heater or cooler connected to the outer passage ends feeds a hot or cold fluid through the passage and thereby heats or cools at least a portion of the faces of the cutting board.

### FIELD OF THE INVENTION

The present invention relates to a cutting board. More particularly this invention concerns a plastic cutting board for household or gastronomic use.

### BACKGROUND OF THE INVENTION

Such a cutting board is known, in particular, hot plates are also known which, if necessary, are also suitable for cutting the products placed on them.

Mainly however, it is desirable to keep food cold outside of specially set up coolers, especially before preparing or serving this food. This is especially true for fish and meat, otherwise microbes and bacteria can multiply and become toxic. Products that are to be stored when ready to serve, such as desserts, also need to be kept cold, although standard enclosed equipment is usually too expensive for wide use.

### OBJECTS OF THE INVENTION

It is therefore an object of the present invention to provide an improved cutting board.

Another object is the provision of such an improved cutting board that overcomes the above-given disadvantages, in particular that is easy and convenient to use and handle, easy to clean and versatile.

### SUMMARY OF THE INVENTION

A cutting board for domestic or gastronomic use. The board has according to the invention a flat plate having an outer surface formed by pair of opposite faces and a peripheral edge. The plate is formed between the faces and within the edge with a passage having ends open at the outer surface, and means connected to the outer passage ends for feeding a hot or cold fluid through the passage and thereby heating or cooling at least a portion of at least. The advantage of the invention consists essentially in the fact that the plastic plate can be used for both cooling and heating. And it is easy to clean depending on the material, especially since the cooler or heater is arranged separately from the plastic plate.

In a preferred embodiment of the invention the plastic plate is food safe, in particular of polypropylene or hard polyethylene. For example rigid polyethylene can be used in temperature ranges from −40 to +110° C. This is why it is also very popular for packaging food, chemicals and cosmetics, among other things.

According to a first embodiment of the invention, water can be provided as the fluid medium for cooling to just above 0° C. or for heating, which has the advantage of being harmless in any case when processing food.

Alternatively, however, there is also the possibility of using a food-safe organic substance such as propylene glycol or the like as the fluid medium for cooling.

In order to connect the plastic plate and the cooler or heater as simply as possible, in an advantageous embodiment the passage is provided at its ends with connector fittings for connection to the cooler or heater. These connector fittings are drip-proof quick-release couplings, since this ensures quick coupling and uncoupling of the cooler or heater.

In order to reduce the risk of injuries and to facilitate cleaning of the plastic plate, the connector fittings are fixed at a side edge of the plastic plate.

Depending on the application and intended use, a small cooler dimensioned to only cool the plastic plate or a central cooler can be provided as the cooler supplying the fluid medium.

In order to be able to use both faces of the plastic plate, the passage is approximately central with respect to the cutting faces of the plastic plate. This makes it possible to double the service life by turning the cutting board. However, a somewhat asymmetrical, i.e. off-center, arrangement of the passages is also conceivable, if, for example, a lower or higher temperature is desired in a restricted zone of the board.

In order to achieve a uniform temperature over the surface, it is advantageous however if the passages run in a meandering, evenly spaced array.

In order to also make cleaning easier, the plastic plate should have as few corners as possible. It is therefore advantageous if the plastic plate preferably is rectangular.

In order to make the possible uses of the cutting board as wide as possible, it is provided with connectors for attachments to or in add-on parts such as an enclosing frame. Additional aids for food preparation such as a portioning aid can thus easily and safely be connected to the cutting board.

There are many design options for this. A particularly simple and quick-to-use possibility is that the connecting elements are formed by magnets.

Finally, it can be advantageous, possibly also necessary in accordance with legal regulations, for the plastic plate to be provided with antibacterial additives.

### BRIEF DESCRIPTION OF THE DRAWING

The above and other objects, features, and advantages will become more readily apparent from the following description, reference being made to the accompanying drawing in which:

FIG. 1A is a plan view of the cutting board of this invention;

FIG. 1B is a side view of the cutting board;

FIG. 1C is an end view of the cutting board;

FIG. 1D is a perspective view of the cutting board

FIG. 2A is a plan view of another cutting board of this invention;

FIG. 2B is a side view of the cutting board of FIG. 2A;

FIG. 2C is an end view of the cutting board of FIG. 2A; and

FIG. 2D is a perspective view of the cutting board of FIG. 2A.

### SPECIFIC DESCRIPTION OF THE INVENTION

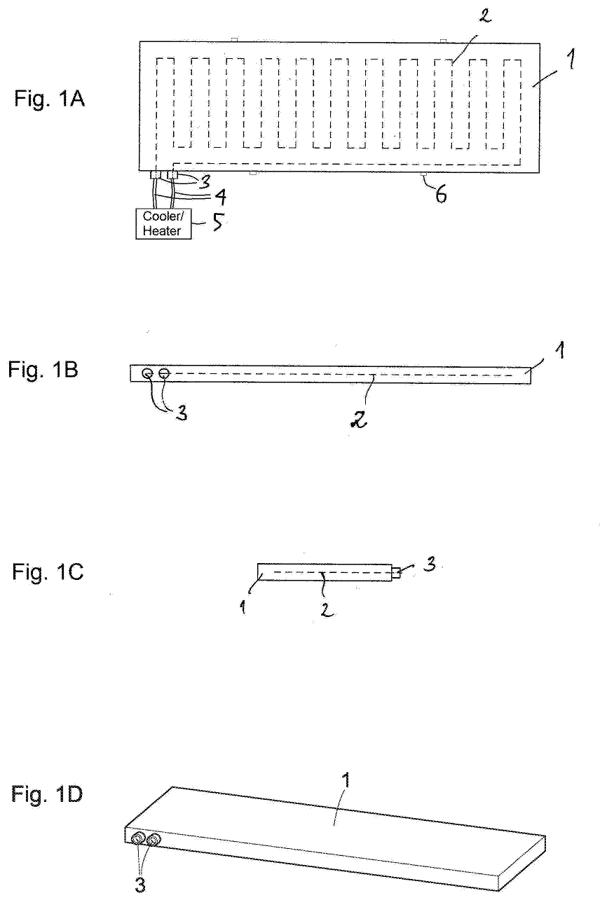

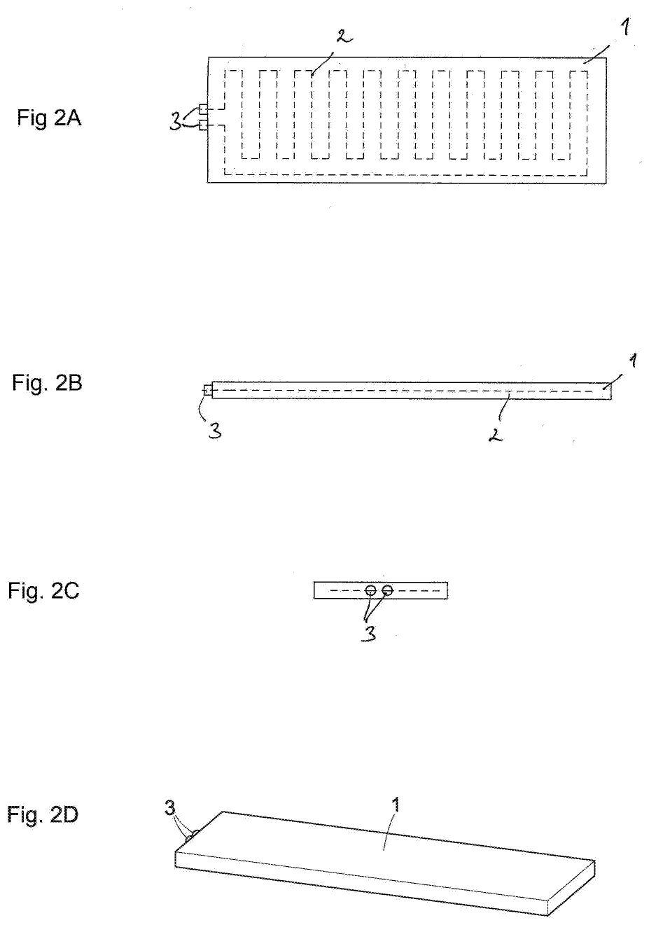

As seen in FIG. 1A-1D the cutting board shown schematically in the drawing is suitable for both domestic and gastronomic purposes and consists of a plastic plate 1 provided with one or more internal passages 2. These passages 2 can be fed with a fluid or gaseous fluid medium for cooling or heating. For this purpose, a cooler or heater 5 is connected via flexible hoses 4 to the ends of the passage 2 to supply it with a fluid medium.

Specifically, the plastic plate 1 consists of food-safe plastic, in particular of polypropylene or hard polyethylene, but other plastic materials suitable for the intended use can also be used.

If the desired temperature range remains above the freezing point of water, water can be used as the fluid medium for cooling or for heating.

Of course, other substances can also be used; a food-safe organic substance such as propylene glycol or the like can also be used as the fluid medium for heating and/or cooling.

The passage 2 is provided at its end with connector fittings 3 for connection to the cooler or heater, in a manner not shown in detail in the drawing.

In order to be able to easily separate the cutting board from the cooler or heater, the connector fittings 3 are drip-proof quick-release couplings.

In order to facilitate handling, in particular during cleaning, the connector fittings 3 terminate in at an edge opening parallel to planes of the opposite faces of the plastic plate 1.

The cooler/heater can be designed as a small unit that only serves to supply the plastic plate 1. It is also conceivable that the cutting board is connected to a central cooler.

As can be seen from the drawing, the passag 2 is formed by a number of parallel sections that are equispaced between the planar opposite faces of the plastic plate 1. They run in a meandering, evenly spaced arrangement so a uniform temperature can be achieved over the cutting faces.

In principle, depending on the products to be processed, the plastic plate 1 can have any shape. Normally however, as can be seen in the drawing, it will preferably be rectangular.

In a manner also not shown in the drawing, the plastic plate 1 can have connectors 6 for attachment to or in add-on parts such as an enclosing frame, which greatly expands the area of application and the possible uses. For this purpose, the connectors can be magnets, but other attachments are also conceivable and suitable.

Finally, especially in the case of sensitive or easily perishable products, it can be useful if the plastic plate 1 is provided with antibacterial additives

I claim:

1. A cutting board for domestic or gastronomic use, the board comprising:
a flat plate having an outer surface formed by pair of opposite faces and a peripheral edge, the plate being formed between the faces and within the edge with a passage having ends open at the outer surface; and
means connected to the outer passage ends for feeding a hot or cold fluid through the passage and thereby heating or cooling at least a portion of at least.

2. The cutting board according to claim 1, wherein the flat plate is made of polypropylene or hard polyethylene.

3. The cutting board according to claim 1, wherein the fluid is water above 0° C.

4. The cutting board according to claim 1, wherein the fluid is propylene glycol.

5. The cutting board according to claim 1, whe313rein the means includes connection fittings fixed in the plat at the passage ends.

6. The cutting board according to claim 5, wherein the fittings are drip-proof quick-release couplings.

7. The cutting board according to claim 5, wherein the fittings are fixed on the edge of the plate.

8. The cutting board according to claim 1, the means is a cooler dimensioned to cool only the plate.

9. The cutting board according to claim 1, wherein the passage extends centrally in the plate.

10. The cutting board according to claim 9, wherein the passage extends in a uniform meander in the plate between the faces and within the edge thereof.

11. The cutting board according to claim 1, wherein the plate is rectangular.

12. The cutting board according to claim 1, further comprising
formations on the outer surface for connection of a frame.

13. The cutting board according to claim 1, wherein the formations are magnets.

14. The cutting board according to claim 1, wherein the plastic forming the plate includes antibacterial additives.
